(19) United States
(12) Patent Application Publication
(10) Pub. No.: US 2013/0235728 A1
(43) Pub. Date: Sep. 12, 2013

(54) ESTIMATION OF ACCESS QUALITY IN MOBILE COMMUNICATION SYSTEMS

(71) Applicants: Khiem Le, Coppell, TX (US); Wing Lo, Plano, TX (US); Wei Wu, San Jose, CA (US)

(72) Inventors: Khiem Le, Coppell, TX (US); Wing Lo, Plano, TX (US); Wei Wu, San Jose, CA (US)

(21) Appl. No.: 13/797,293

(22) Filed: Mar. 12, 2013

Related U.S. Application Data
(63) Continuation of application No. PCT/US2012/028262, filed on Mar. 8, 2012.

(51) Int. Cl. H04W 28/12

(52) U.S. Cl. CPC H04W 28/12
USPC 370/236; 370/252

(57) ABSTRACT

Communicating between a first node in a network and a second node includes determining, by a third node in the network that is in communication with the first node, a value of an additive path quality metric for a path segment between the third node and a fourth node, and a value of the additive path quality metric for a path segment between the third node and a fifth node. Path quality is estimated for each of multiple different paths between the first node and the second node based at least in part on the values of the additive path quality metric determined by the third node. At least two of the multiple different paths include at least one path segment in common.

### FIELD

The present application generally relates to communicating with a node in a network, and in particular to techniques for efficient estimation of access quality in mobile communication systems.

### BACKGROUND

In networks that provide access to mobile devices, at any given time there may be multiple paths between a mobile device and a particular correspondent node in the network. Determining the quality of a path in a network before sending data traffic on that path is useful in many applications. The quality of a path may depend, for example, on the available bandwidth of the path. Estimates of path quality can be used, for example, to select an optimal route, to perform admission control, to perform congestion control, or to adjust the rate at which data is sent. For example, a mobile device that communicates with a correspondent node in the network may have a choice among multiple paths to the correspondent node through any of a variety of access points (APs), each corresponding with the correspondent node over a different path. The mobile device may select the best path according to path quality information that is based on a path quality criterion, such as which path has the lowest congestion. The path quality information can be provided to the mobile device for making the selection, or the path quality information can be provided to a different entity that selects the path to be used by the mobile device, and communicates the selected path to the mobile device. Selecting a path with low congestion may result in a better experience for the user of the device, and more efficient network resource utilization.

### DESCRIPTION OF DRAWINGS

FIG. 1 is a block diagram of a mobile communication system.

FIG. 2A is a schematic diagrams showing segments of paths through nodes in a mobile communication system.

FIG. 2B is a schematic diagram showing the operations that may be used in path selection.

FIG. 3 is a communication diagram for an attachment procedure.

FIG. 4 is a communicating diagram for an exemplary traffic flow.

FIG. 5 is a schematic diagram of concatenated tunnels.

FIG. 6 is a communication diagram for an attachment procedure.

FIG. 7 is a schematic diagram showing segments of paths through nodes in a mobile communication system.

FIG. 8 is a communication diagram for an estimation procedure.

FIG. 9 is a flowchart of an estimation procedure.

FIG. 10 is a block diagram of a general purpose computer suitable for use in a node or wireless device in a communication system

### DESCRIPTION

In access technologies, such as a Wireless Local Area Network (WLAN), which do not provide support for Quality-of-Service (QoS) attributes for bearer services in the network, mobile devices are able to measure the received signal strength (RSS) of signals from an AP, and use it as a criterion to determine the quality of the corresponding path through that access point (e.g., a high RSS indicates a high quality path). However, the RSS by itself may not always be a reliable criterion, because the actual path quality may also depend on other factors such as interference level, or congestion level, which may depend on traffic load at the AP and traffic load on the backhaul network or other network infrastructure behind the AP. Therefore, the AP with the highest RSS does not necessarily provide the highest quality path to the correspondent node.

The congestion level of a path may be estimated by measuring the round trip time (RTT) associated with the path as it is used for communicating to and from the correspondent. In some schemes, RTT estimation is based on measuring, for a given flow of packets, the time elapsed between a packet and its acknowledgment (ACK), and averaging multiple sample RTT measurements. For example, for a TCP connection over a particular path, the sender is able to estimate the RTT of the connection (or a flow of packets using the connection) by measuring the time elapsed between a TCP data segment and the corresponding TCP ACK of that data segment. In such approaches, estimating the RTT of a path may include collecting data based on existing traffic or previously transmitted traffic. In an alternative approach, estimating the RTT of a path may include sending and receiving traffic over the path that is specifically for performing the measurement. For example, the traffic may include probes known as pings, or chirps. Metrics for estimating path quality other than RTT can also be used.

A scheme for characterizing path quality estimates the quality of different paths over nodes between a mobile device and a correspondent node, for example, based on a metric that is additive over multiple segments of the paths. Each segment includes one or more links between nodes. Round trip time (RTT) is an example of an additive metric, where the metric value for an entire path made up of multiple segments is equal to the sum of the metric values for the individual segments. Another example of an additive metric for estimating path quality is a count of packet losses (e.g., a number of packets that were sent by one node but not successfully received by another node). The count of packet losses for an entire path is equal to the sum of the packet loss counts for the individual segments making up the path. For the purpose for comparing different paths, the packet loss count may be converted to a packet loss rate. The scheme can be used to estimate the additive path quality metric, without requiring the device to send or receive traffic on the path during the estimation. The estimated additive path quality metric can be used to derive path quality information, which can be used as input to select one or more paths for routing packets between the mobile device and the correspondent node, according to an optimality criterion, when multiple candidate paths are available. In some implementations, one or more nodes in the network also participate in selecting the optimal path. Some implementations of the quality estimation scheme exploits certain properties of tunneling protocols such as Mobile IP and its variants, which may be applicable to a variety of network architectures that enable wireless access, such as WLAN, or 3GPP. An example of Mobile IP variant is Proxy Mobile IPv6 (PMIPv6). In what follows, the term “Mobile IP” is used to refer generically to Mobile IP and its variants. For example, in many cases (e.g., when the traffic is tunneled), a segment of a path between two nodes along the path is shared by multiple traffic flows or users. Therefore the quality of the shared path segment can be estimated with high accuracy and minimal overhead by measuring the RTT of the current or recent traffic on the segment. A high RTT for the segment indicates potential congestion caused by a high load on that segment, and therefore a low quality for that segment.

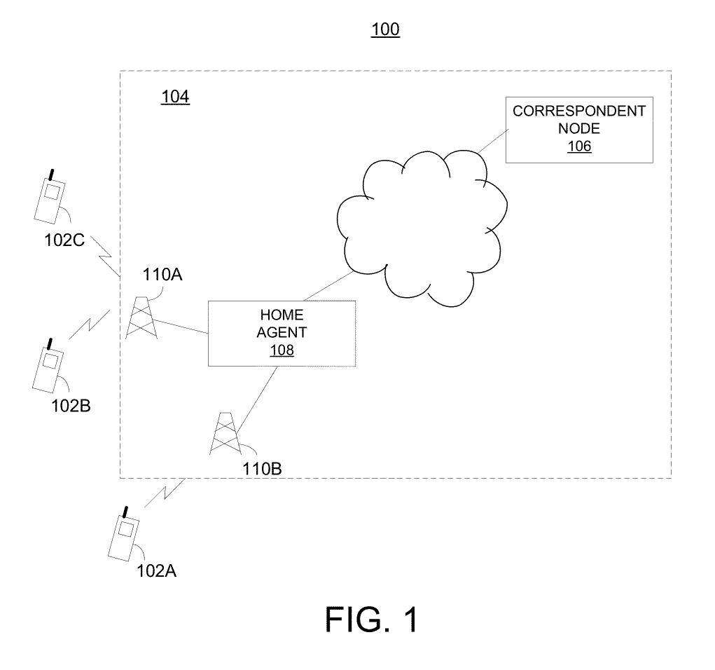

FIG. 1 shows an exemplary mobile communication system 100 for providing mobile nodes 102A-102C (representing different mobile devices) access to a network 104. The network 104 may include any number of networks interconnected with each other. The network 104 may include any type or form of network(s) including any of the following: a wide area network (such as the Internet), a local area network, a telecommunications network, a data communication network, or a computer network, for example. The network 104 may include any number of routers, switches, repeaters, appliances, devices, servers, and storage media, for example, interconnected by a variety of communication media.

While various mobile network architectures may be used, to illustrate various aspects of the scheme, an exemplary Mobile IP-based architecture will be described in which a particular end-to-end path is between a particular correspondent node (CN) within the network, such as CN 106, and a particular mobile node (MN), such as MN 102A. The MN accesses the network through an access point (AP), which may provide access according to any of a variety of protocols or network architectures. In this exemplary architecture, a particular end-to-end path is a concatenation of two segments: segment 1 between the CN 106 and a Home Agent (HA) 108, and segment 2 between the HA 108 and the MN 102A. Therefore, the total RTT associated with the end-to-end path is equal to the sum of RTT1 and RTT2, where RTT1 and RTT2 are the round trip times for segments 1 and 2, respectively. The HA 108 serves as a mobility anchor, such that when a mobile device changes location and accesses the network through a different AP, the nodes in segment 1 remain the same, even though the nodes in segment 2 change. In this example, segment 2 includes an AP 110A between the HA 108 and the MN 102A on a first path, but communication may change to a second path through AP 110B (e.g., in response to MN 102A changing location). Thus, in order to select the AP node that corresponds to the optimal path, RTT1 does not need to be estimated since each potential path through different respective AP nodes have the same RTT1. Instead, it is sufficient to estimate RTT2 for each path and select the path, and corresponding AP, that has the best (lowest) RTT2. In many situations, it is advantageous for a MN to estimate RTT2 of a path based on current or recent traffic from other MNs since it does not require sending traffic on a path to a CN; however, in some cases, as an alternative for when there is no current or recent traffic through a particular HA, the MN is able to obtain an estimate of RTT2 by a direct measurement that involves sending traffic to the HA (e.g., sending a ping or measuring the round trip time associated with the Mobile IP signaling between the MN and the HA).

The RTT2 for a path to a given MN is the sum of RTT2_{common} and RTT2_{specific}, where RTT2_{common} is the round trip time for the segment between the HA and the AP, and RTT2_{specific} is the round trip time for the segment between the AP and the MN. RTT2_{common} depends on the traffic load on the network path segment between the HA and the AP, and will exhibit similar statistics for any of multiple paths to different MNs that share the same path segment between HA and AP and that carry traffic belonging to the same traffic class. RTT2_{specific} for a path to a particular MN depends substantially on the wireless transmission conditions between the AP and that particular MN. The wireless transmission conditions at a MN can be estimated based on the RSS of signals received by that MN, for example.

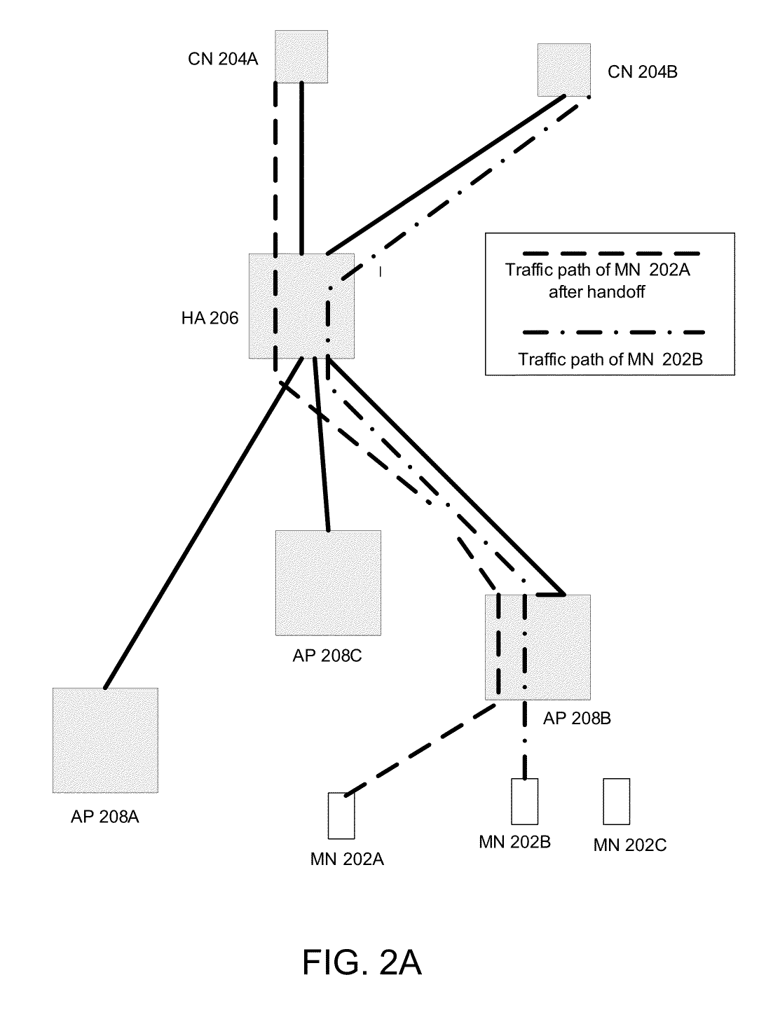

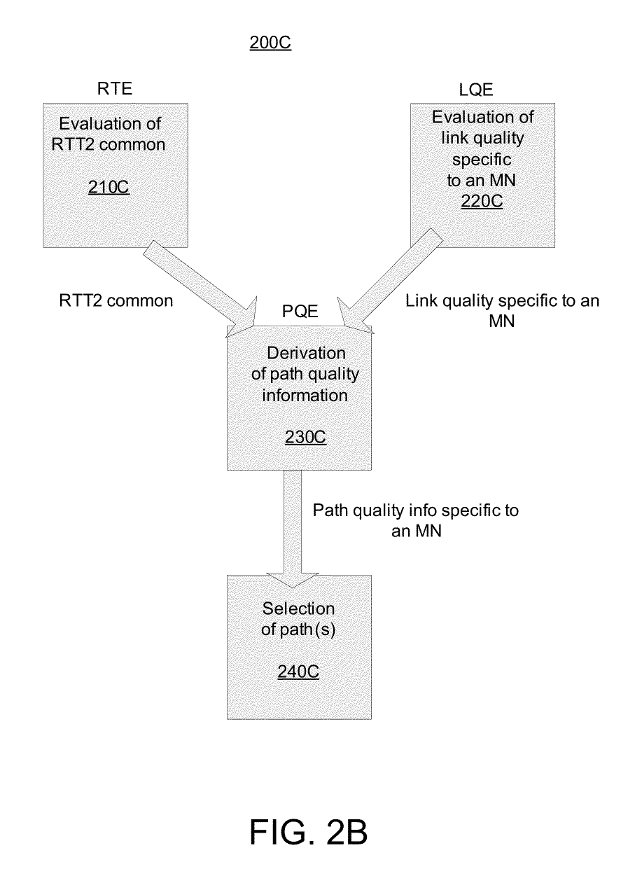

Referring to FIG. 2A, a MN 202A may have been communicating over a path through AP 208A, and may have determined that a handoff procedure should be performed to change to a path through a different AP as the mobile device represented by MN 202A moves. In this example, the MN 202A has determined it needs to handoff communication from AP 208A to one of AP 208B or AP 208C. To select the best AP to handoff to, the MN 202A estimates the quality of the path corresponding to each AP, in order to select the path with the higher estimated quality. Segment 1 between the CNs and the HA, and segment 2 between the HA and the APs, shown as solid lines connecting the end point nodes, each represents a path segment that may include any number of intermediate nodes between the end point nodes. The two paths have the same segment 1 between CN 204A and HA 206. The MN 202A estimates the quality of a first segment 2 between HA 206 and MN 202A through AP 208B, and of a second segment 2 between HA 206 and MN 202A through AP 208C, in order to choose the path with the highest quality. The estimation procedure uses measurements of RSS from each AP to estimate RTT2_{specific} for each corresponding path, and uses stored RTT2 statistics based on other MNs that are currently communicating (or have recently communicated) over the segment between HA 206 and AP 208B or the segment between HA 206 and AP 208C to estimate RTT²_{common} for each path. RTT2_{common} for the segment between HA 206 and AP 208B can be estimated from the RTT2 statistics collected for recent traffic of MNs using AP 208B, which in this example includes recent traffic from MN 202B and MN 202C. Similarly, RTT2_{common} for the segment between HA 206 and AP 208C can be estimated from the RTT2 statistics collected for recent traffic of MNs using AP 208C. The path for recent traffic of MN 202B used for collecting statistics does not necessarily need to share the same segment 1 as the path being evaluated, as shown in FIG. 2A by the dashed-dotted line representing the traffic path of MN 202B, which connects to a CN 204B. However, the recent traffic of MN 202B does share the same segment 2 as the path being evaluated. In this example, the path through AP 208B is selected, shown as the dashed line representing the traffic path between MN 202A and CN 204A after handoff. The HA 206 collects RTT2 statistics based on sampled measurements of RTT2 and optionally other information determined by, or received at, HA 206. Since RTT2 samples may fluctuate, the RTT2 statistics can be based on multiple RTT2 samples for traffic observed over a selected period of time that is long enough to provide accurate statistics and short enough to reflect relatively recent traffic conditions. To measure an RTT2 sample, the HA 206 measures the time elapsed between a packet sent to a MN and the corresponding acknowledgment received from the MN. The HA 206 may perform various tasks to manage information for different RTT2 sample measurements. For example, the HA 206 matches IP addresses with APs, in order to assign an RTT2 sample to a specific AP. An example of a protocol in which acknowledgments are sent and received in this manner is Transmission Control Protocol (TCP). The RTT2 sample values can be processed to obtain meaningful statistical measures for different path segments. For example, samples can be aggregated over multiple MNs in communication with the HA 206 through a particular AP (for example, for AP 208B, the samples can be aggregated over MN 202B and MN 202C). The samples for a particular AP (and therefore for a particular RTT2_{common}) can also be averaged over time. For example, the HA 206 can calculate a moving average of RTT2 sample values.

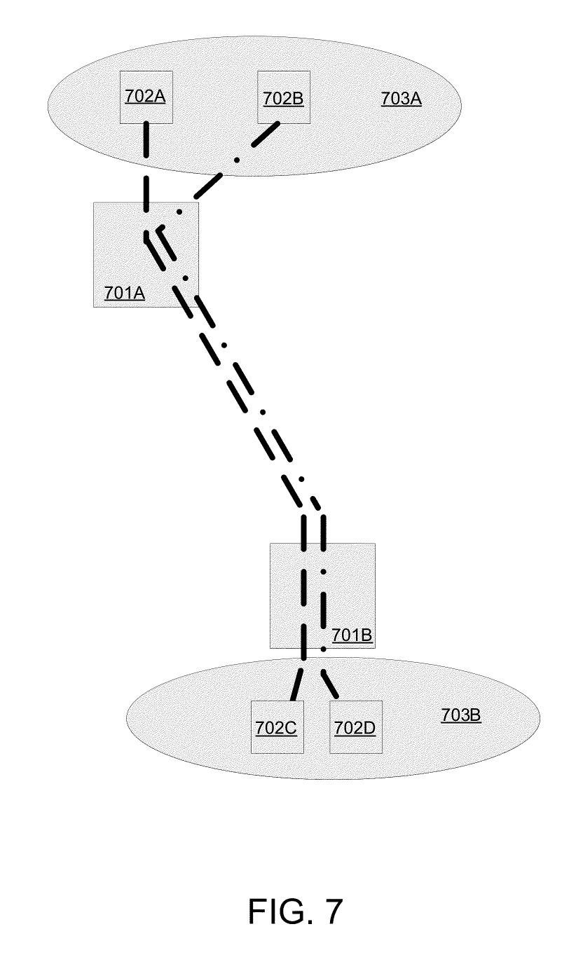

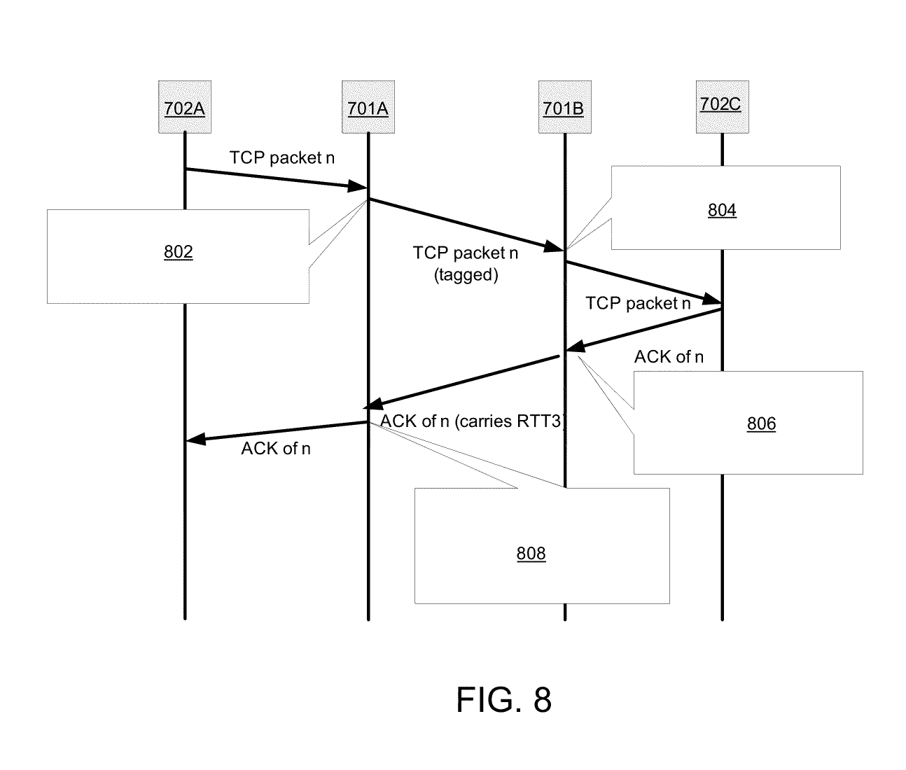

When a particular MN (e.g., MN 202A) is estimating RTT2 for a particular path to itself based on RTT2 statistical data collected from paths to other MNs, the MN first determines the RTT2_{common} for the path segment shared by the paths, and then determines the RTT2_{specific} for the particular path to itself When determining RTT2_{common} from a statistical RTT2 value, since RTT2=RTT2_{common}+RTT2_{specific}, a low value of RTT2 indicates that RTT2_{common} is at least as low. However, a high value of RTT2 may be a result of RTT²_{specific} for the other MNs (e.g., MN 202B and MN 202C) being high (e.g., due to persistently poor wireless transmission to those MNs) and does not necessarily imply that RTT2_{common} is high. In such cases, the value of RTT2_{common} can be estimated using additional procedures. Some RTT measurement procedures involve calculations performed at one end node of a path segment (e.g., HA 206) and do not require the other end node of the segment (e.g., AP 208B) to perform any calculations for the RTT measurement, which is advantageous for some networks by enabling APs to be used without modification. Other RTT measurement procedures involve calculations performed at both end nodes of the path segment (e.g., the segment between HA 206 and AP 208B for measuring RTT2_{common}), as described in more detail below with reference to FIGS. 7 and 8.

In one example of a path selection procedure, MN 202A queries HA 206 for the RTT2 statistical data for different candidate paths and uses respective RTT2 values as a path quality metric to determine whether to initiate a handoff procedure to a new path, or to maintain the current path. In another example, the MN 202A has determined that a handoff procedure is necessary, and queries the HA 206 to obtain values of the path quality metric used to select one of multiple candidate APs to which to handoff. In the case of technologies like WLAN, for example, MN 202A is able to use RTT2 statistical data to estimate RTT2_{common}, and is able to use RSS values of signals from different APs to estimate RTT2_{specific}, which enables a determination of the total RTT2 for the highest quality path. For example, candidates paths through AP 208B and AP 208C may have comparable RSS values, but AP 208B may be preferred if it is on the path that has a lower RTT2 value. Other selection procedures are possible.

Another use case is multi-path communications. For example, a MN (e.g., MN 202A) may be connected to a correspondent node through multiple APs, with each AP corresponding to a path. In the example of a flow from the CN 204A to MN 202A, the HA 206 selects a path. To select the path with best quality, the system estimates the RTT. Because segment 1 is the same for all candidate paths, it is sufficient to compare quality of the candidate paths based on their RTT2. Because information from previous MNs sharing segment 2 can be used, a current RTT2 estimate can be achieved even if there has been no MN 202A traffic on the segment 2 for some time.

The following example describes an implementation of a path selection procedure that may be used in the context of a Proxy Mobile IPv6 (PMIPv6) protocol, which is a version of Mobile IP used in the 3GPP Evolved Packet Core (EPC) protocol. However, the path selection procedure can also be implemented using other protocols. In PMIPv6, the HA is called the Local Mobility Anchor (LMA), and the AP is configured to perform functions of a network entity called the Mobile Access Gateway (MAG). The MAG acts on behalf of a MN to carry out certain mobility signaling and procedures, so the MN does not need to participate in those mobility signaling and procedures in order to use the mobility services of the network. In some of the following examples, some of the interactions between the MAG and other functions of the AP will be described, but the terms MAG and AP both refer to the node that provides MNs access to the network.

The following is a summary of an exemplary PMIPv6 attachment procedure to establish a segment 2 of a path when a MN attaches to an AP. The order of nodes along this segment 2 is: MN, AP (referred to in this example as MAG), HA (referred to in this example as LMA). The procedure results in a bidirectional mobility tunnel between the LMA and the MAG used for traffic to and from the MN. (Other procedures are used when there is a handoff from one AP to another AP. For example, a PMIPv6 handoff procedure would also involve detachment at the old AP, and removal of the tunnel between the old AP and the HA.)

1. When a MN initiates attachment to a new AP, the AP triggers the MAG functionality, and the MAG, after identifying the MN (or otherwise acquiring its identity), will determine if the MN is authorized to use the network mobility services. If so, the MAG builds a Proxy Binding Update (PBU) message for the LMA. The PBU is similar to the Binding Update in MIPv6, except that it is sent by the MAG acting as proxy on behalf of the MN.

2. The MAG sends the PBU to the LMA, and the source IP address of the MAG is the Proxy-Care-of-Address (Proxy-CoA).

3. The LMA performs the necessary verifications and determines the Home Network Prefixes) (HNP) for the MN. The LMA creates a binding cache entry to map the HNP(s) to the Proxy-CoA, and builds a Proxy Binding Acknowledgment (PBA) carrying the HNP(s). PBA is similar to the Binding Acknowledgment in MIPv6, except that it is destined for the MAG acting as proxy on behalf of the MN.

4. The LMA sends the PBA to the MAG.

5. The MAG sets up a tunnel towards the LMA if a tunnel is not already set up.

6. The MAG sends a Router Advertisement to the MN, to provide the MN with information to configure its address on the AP (based on the HNP).

As a result of the above attachment procedure, the MAG and the LMA are established as the two end-points of a bidirectional mobility tunnel that can be used to carry traffic to and from the MN. The Proxy-CoA is the global address configured on the egress interface of the MAG and is the transport end-point of the tunnel The LMA address (LMAA) is the global address configured on the interface of the LMA and is the other transport end-point of the tunnel After the tunnel is established, traffic to and from the MN can be handled as follows. When the LMA receives a packet destined for the MN (i.e., having the HNP determined during the attachment procedure in the destination IP address of the packet), the LMA encapsulates that packet in another packet with outer destination IP address equal to the Proxy-CoA, and sends the packet through the tunnel. With IP routing, the packet will be received by the MAG which will decapsulate and forward the packet to the MN. In the other direction, when the MAG receives a packet from the MN, the MAG encapsulates the packet in another packet with outer destination IP address equal to the LMAA, and sends the packet through the tunnel With IP routing, the packet will be received by the LMA which will decapsulate and forward the packet to the destination (e.g., a CN).

FIG. 2B is a schematic diagram 200C showing the operations that may be used in path selection. Generally, the operations described in diagram 200C may be performed for example, using the systems described in FIG. 1 (e.g., mobile communications system 100). In a general sense, operation 210C is the evaluation of RTT2_{common}, done by the RTT2 Common Estimator (RTE). The RTE could be located at the anchor node (ANCH) (e.g., the LMA or other node acting as an HA) and/or the device. In operation 220C, the evaluation of the link quality specific to an MN, is done by the Link Quality Estimator (LQE), for example, by measuring the Received Signal Strength (RSS). The LQE could be located at the device and/or the AP. In operation 230C, the derivation of path quality information for a specific device, takes as input the RTT2_{common} and the link quality specific to an MN. An example of path quality information is an estimated RTT2, which is the sum of RTT2_{common} and an estimated round trip time on the link specific to an MN. Operation 230C is performed by the Path Quality Estimator (PQE). The PQE may be located at the device and/or some other entity. Operation 230C includes the selection of one or more paths, based on the path quality information and possibly other considerations such as policy. A policy could be, for example “use WLAN access belonging to operator Y, unless none of the operator Y's access points has an acceptable performance”. Operation 240C may be performed by the Path Selector (PS). The PS may be located at the device, and/or some other network based entity. Depending on the locations of RTE, LQE, PQE, PS, some signaling between them may be involved. For example, if the RTE, LQE, PQE and PS are located at the ANCH, device, device and/or a portion of a network node, respectively, signaling between the device and the ANCH (for the PQE to obtain RTT2_{common} from the RTE) may be used to exchange information. Signalling also may be used between the device and the network node (for the PS to obtain the path quality information from the device and for the device to learn from the PS which path is selected).

More precisely, in operation 210C, RTT2_{common} is evaluated in a first substep (not shown). The RTT2_{common} may be derived from a variety of RTT2 samples for a given AP. Specifically, an anchor node selects a packet from those routed to/from that AP. For the selected packet, the anchor node measures the time elapsed between the packet being sent out from the anchor node towards the MN and the corresponding acknowledgment from the MN being received by the anchor node. An example of a protocol in which the MN sends acknowledgments in response to the reception of a packet is Transmission Control Protocol (TCP). The anchor node may be configured to determine what packets are routed to/from a given AP, and to that end, the anchor node maintains a mapping between destination IP addresses and AP identifiers. Since RTT2 samples may fluctuate, the RTT2 statistics can be based on multiple RTT2 samples for traffic observed over a selected period of time that is long enough to provide accurate statistics and short enough to reflect relatively recent traffic conditions.

The RTT2 sample values may be processed to obtain meaningful statistical measures. For example, samples can be aggregated over multiple MNs in communication with the anchor node through a particular AP (for example, for AP 208A, the samples can be aggregated over MN 202B and MN 202C). The samples can also be averaged over time for a given AP. The anchor node also may calculate a moving average of RTT2 sample values for a given AP.

The anchor node may be configured to establish a mapping between IP addresses and AP identifiers. Put differently, the anchor node may establish and maintain a mapping between IP addresses and AP identifiers to be able to determine what packet to select to sample the RTT2 for a given AP. PMIPv6, and AP-ANCH signaling may be used.

In a second substep of operation 210C, the RTT2_{common} is estimated (not shown). Two approaches may be used. In one approach that will be described later, a bounding approach may be used. In another approach an RTT subtraction approach may be used. In the RTT subtraction approach, RTT2_{common} is obtained by subtracting RTT2_{specific} from RTT2, for specific packets. RTT2_{specific} is measured by the AP.

In operation 220C, link quality specific to an MN is evaluated. An example of link quality includes the received signal strength (RSS).

In operation 230C, path quality information is derived by combining the quality information of the network segment (segment between ANCH and AP) and of the link specific to an MN (segment between AP and MN). An example of path quality information is the RTT2=RTT2_{common}+RTT2_{specific}, where RTT2_{specific} is estimated from RSS. Another example is a composite (RTT2_{common}, RSS) tuple. Still, another example may include a tuple (Network segment quality, RSS). A network segment quality may be the estimated loading level of the segment between ANCH and AP, derived from the RTT2_{common} and the past history of RTT2_{common} values. This may be identified with a network segment quality as being at a “50% load”.

The ANCH-AP signalling may be used so that the ANCH and AP agree on what packets should have their round trip time measured. For example, implicit tagging may be used, where the tagging template can be signaled in-band or out-of-band.

The ANCH-AP signalling may be used so that the ANCH knows which packet is routed to/from which AP (Mapping between IP addresses and AP identifiers). This can be done by using AP-X signalling to the ANCH, that say, TCP connection Y is transiting through the AP-X. Signalling also may take place as a result of the AP detecting the TCP connection, (at TCP connection establishment or when TCP connection is transferred to AP-X due to MN's mobility). A packet that is tagged and belongs to TCP connection Y will have its elapsed time between its transmission and the receipt of a corresponding acknowledgement (T_Elapsed) measured by the AP-X. The AP may be configured to report T_Elapsed results to the ANCH. This can be done using in-band signaling or out-of-band signaling.

In operation 240C, one or more paths may be selected. If the path quality info is the RTT2, the best performing path is the one with lowest RTT2 may be selected. Path selection may take into account other considerations than performance, such as policy. If the path quality info is the composite tuple (RTT2_{common} RSS), paths may be selected as follows (as an example): Eliminate the APs whose RSS is below some threshold, and among the ones that remain, choose the one with lowest RTT2_{common}. If the path quality info is the composite tuple (Network path quality, RSS), paths may be selected as follows (as an example): Eliminate the APs whose RSS is below some threshold, and among the ones that remain, choose the one with best network path quality. In all these cases, path selection may take into account other considerations than performance, such as policy.

Additionally, the PS can select paths to balance the load so that a high quality path does not get selected by too many concurrent or quasi concurrent requests and consequently be overwhelmed by new traffic.

Note the PS may be configured as a functional entity which could be implemented in various ways, at the MN, at a network node, or distributed between the MN and a network node. An example of distributed implementation is when the network node narrows down the selection, and communicates the result to the MN, which applies its own criteria to select the path.

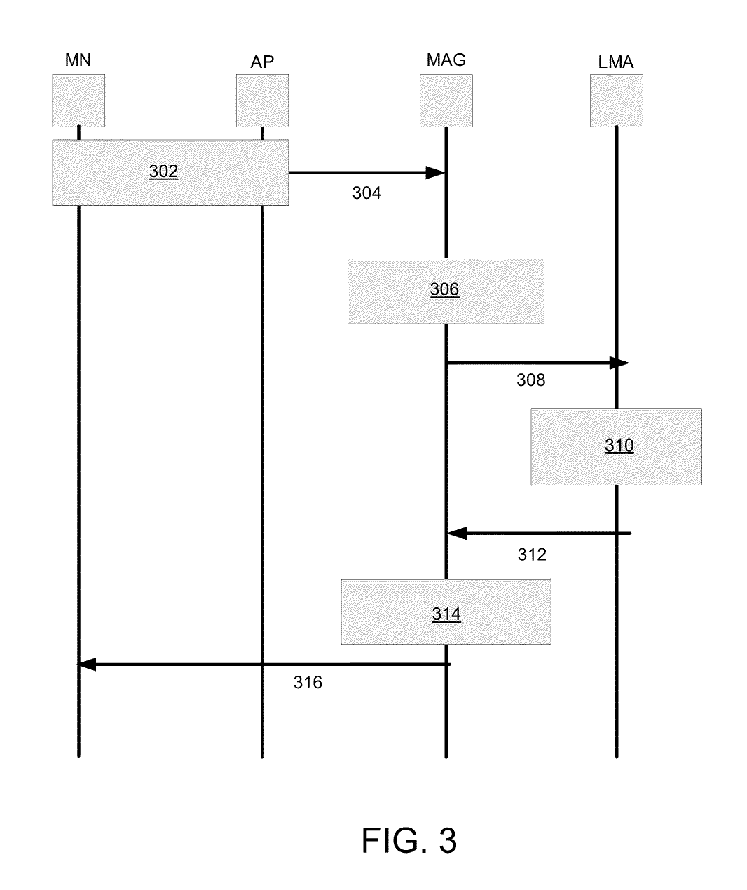

FIG. 3 is a communication diagram showing steps for providing RTT2 statistical data to an MN for path quality estimation after a MN initiates an attachment procedure to an AP. The MN sends (302) a request to initiate an attachment procedure with the AP. The AP triggers (304) the MAG functionality to perform attachment operations as described above (e.g., step 1) including building a PBU. Additionally, if path quality estimation is requested, the MAG associates (306) an AP identifier (identifying the AP that received the attachment request) with a corresponding outgoing PBU. For example, the MAG includes in the PBU the AP identifier, and an indication that an RTT2 estimation procedure is requested. The request can be indicated by a Boolean “RTT2 request” flag also included in the PBU. The value of the “RTT2 request” flag is set to “true” when the RTT2 estimation procedure is requested, which also indicates that an AP identifier is included in the PBU. The MAG sends (308) the PBU to the LMA, as described above (e.g., step 2). The LMA, in response to the PBU, performs attachment operations as described above (e.g., step 3) including allocating the HNP(s). Additionally, if the “RTT2 request” flag is true, the LMA generates (310) an HNP-to-AP identifier mapping, which maps one or more HNPs to the corresponding AP identifier. The HNP-to AP mapping may be maintained at the LMA until the LMA receives signaling indicating the mapping may no longer apply. There may also be a lifetime associated with the mapping. The LMA sends (312) a PBA to the MAG, as described above (e.g., step 4). Additionally, if the “RTT2 request” flag is true, the LMA includes in the PBA the RTT2 statistical data associated with the AP identified by the AP identifier. The MAG sets up (314) the tunnel towards the LMA if the tunnel is not already set up, as described above (e.g., step 5). Additionally, the MAG measures the RTT associated with the PBU, called “PBU_{RTT}”, according to the time elapsed between sending the PBU and receiving the PBA. The MAG sends (316) a Router Advertisement to the MN, as described above (e.g., step 6). Additionally, the MAG includes in the Router Advertisement the RTT2 statistical data received form the LMA and the measured PBU_{RTT}.

The procedure for providing RTT2 statistical data to an MN for path quality estimation can optionally include additional steps. In some implementations, the MAG provides the RTT2 statistical data associated with other APs in communication with the MAG, in addition to the RTT2 statistical data associated with the AP identified by the AP identifier of the AP to which the MN initiates attachment. For example, the procedure illustrated in FIG. 3 can be modified as follows to provide data for multiple APs/candidate paths. Along with the actions of step 2, the MAG includes a list of AP identifiers including AP identifiers for neighboring APs in the PBU, and the AP identifier of the AP to which the MN attempts attachment. Along with the actions of step 4, the LMA sends the RTT2 statistical data for all the APs identified in the list. Along with the actions of step 6, the MAG forwards the RTT2 statistical data for all the APs identified in the list to the MN. Whether a MN receives RTT2 statistical data for multiple candidate paths through respective APs together as described above, or individually through initiating different respective attachment procedures to different APs, after selecting one of the candidates paths based on the received RTT2 statistical data, the attachment to APs of not selected paths may expire if those paths will not be used by the MN.

The RTT2 statistical data provided by the LMA is data that has been previously collected and stored in association with various APs after tunnels have been established and used for communication to and from other MNs that have attached to those APs. For example, after a tunnel is established, the LMA compiles an RTT2 statistical data set for each AP identifier based on measured RTT2 sample values. An RTT2 sample can be measured in various ways. If the protocol being used to send data packets uses acknowledgments (e.g., TCP or SCTP), the LMA measures the time elapsed between a data packet transmission and the corresponding acknowledgment. In particular, when the LMA identifies a received packet destined for a MN that has attached to one of the identified APs (based on the packet having the HNP determined during the attachment procedure in the destination IP address of the packet), the LMA determines the associated AP identifier from the HNP-to-AP identifier mapping established during the attachment procedure. Other PMIPv6 operations, including encapsulation and forwarding on the tunnel, are also performed. In the case of TCP traffic, for example, the LMA starts a timer when the packet is forwarded on the tunnel When the LMA receives the corresponding acknowledgment, the timer value provides a RTT2 sample that contributes to the RTT2 statistical data for the corresponding AP. In some implementations, the LMA performs the RTT2 measurement on original data packet transmissions, and does not perform the measurement if an original packet is to be retransmitted. If traffic that uses acknowledgments is not present, or not visible (e.g., because the TCP header is encrypted), the LMA can alternatively ping the AP to measure RTT2_{common} directly.

An example of a RTT2 statistical data set derived from the measured RTT2 sample values includes the following (measured over a predetermined time period T):
AVG: Moving average of RTT2 sample values, including one or more of an unweighted average, and a weighted average (e.g., an exponentially weighted average).
MAX: Maximum value of RTT2 sample values.
MIN: Minimum value of RTT2 sample values.
VAR: Variance of RTT2 sample values.
SIZE: Number of sample values included in the above statistics.
ATTEMPT: Number of packets for which the HA attempted to measure the RTT2 (this may not always be equal to the number of sample values, since there is a lag until the HA receives the acknowledgments).
DL_{BYTES}: Number of bytes sent by the HA through the tunnel toward the MN.
UL_{BYTES}: Number of bytes received by the HA through the tunnel from the MN.

Other statistical data can be included, such as a histogram of RTT2 sample values, for example.

In one example of a bounding approach, an MN may be configured to use either or both of the RTT2 statistical data collected by the LMA and the PBU_{RTT} measured by the MAG to estimate the RTT2_{common} for a path. For example, if a MN estimates the quality of a candidate path through a particular AP, the MN performs the attachment procedure with that AP and obtains resulting data (RTT2 statistical data, and a PBU_{RTT} value) from the Router Advertisement provided by the MAG functionality of that AP. The MN uses the RTT2 statistical data and the PBU_{RTT} value as input into its path selection procedure. For example, a path selection procedure may include calculating a weighted average of the RTT2 statistical data and the PBU_{RTT}, and select the path with lowest weighted average. When providing data for multiple APs/candidate paths, the LMA measures the RTT2 statistical data for each respective AP identifier, as described above, and uses the RTT2 statistical data as input into a path selection procedure for selecting a portion of the path going towards the MN.

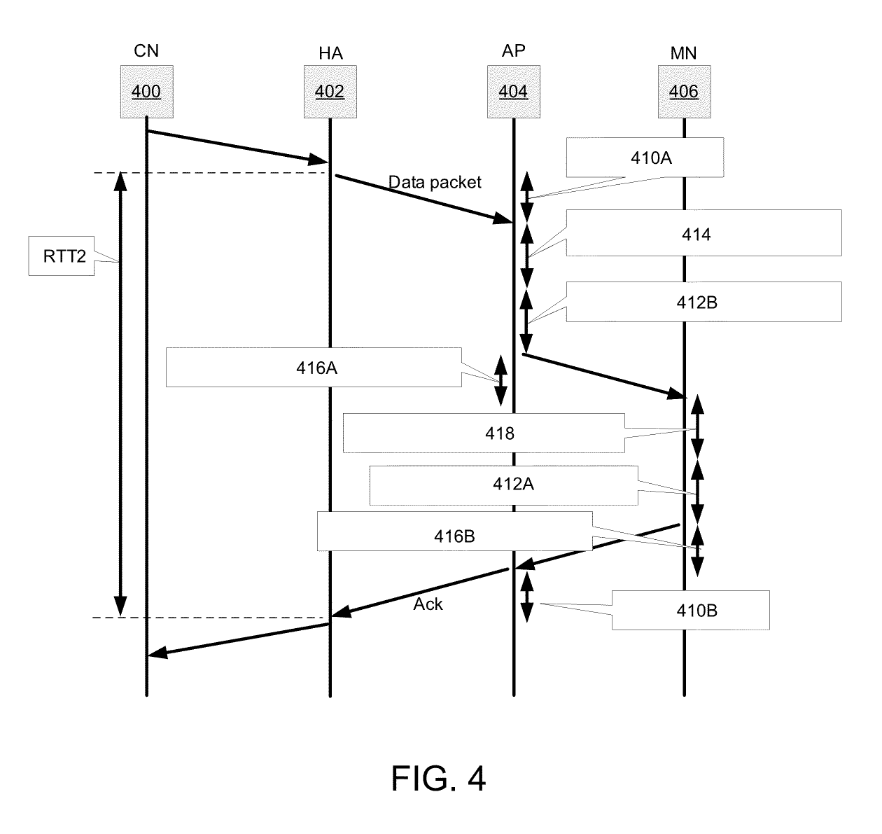

As described above, in some cases, the RTT2 statistical data may not provide an unambiguous evaluation of RTT2_{common} for estimating the path quality. For example, a high value of the moving average of RTT2 may be the result of most of the MNs from which the data was collected experiencing persistently poor wireless transmission conditions, and does not necessarily mean that RTT2_{common} is high. There are various techniques that can be used to estimate RTT2_{common} from RTT2 statistical data. An exemplary technique is based on the observation that RTT2_{common} and RTT2_{specific} can be further subdivided into subcomponents such that: RTT2_{common}=RTT2a+RTT2b, and RTT2_{specific}=RTT2c+RTT2d. Thus, RTT2 can be expressed as RTT2=RTT2a+RTT2b+RTT2c+RTT2d. FIG. 4 is a communication diagram in which time is represented in the vertical direction and the horizontal direction represents propagation of traffic over various path segments between a CN 400, a HA 402, an AP 404, and a MN 406. Time for communication from CN 400 to HA 402, and from HA 402 to CN 400, is not included in RTT2, shown on the left of FIG. 4. Time for communication between the other nodes is included in the subcomponents of RTT2, as follows.

The subcomponent RTT2a represents the portion of the round trip time between the HA and the AP that is associated with the time 410A for a packet to be transmitted from the HA to the AP (the downlink direction), and the time 410B for the corresponding acknowledgment to be transmitted from the AP to the HA (the uplink direction). RTT2a also includes packet processing times associated with the downlink and the uplink directions. The statistics of the RTT2a subcomponent are typically the same for most traffic flowing between the AP and the HA. In PMIPv6, the PBU_{RTT} provides a sample measurement of RTT2a.

The subcomponent RTT2b represents the portion of the round trip time between the HA and the AP that includes uplink (412A) and downlink (412B) access delays. In the downlink direction, the RTT2b component also includes the queuing delay 414 before the packet is transmitted from the HA. Some of the access delays depend on the types of protocols being used. For example, some WLAN protocols use contention-based uplink access, which bring access delays that include: time waiting for the channel to become open for contention, time for a transmission attempt, time for collision, time for back-off, and time for retry. Some protocols use scheduled uplink access, which brings an access delay from the time of a request for transmission to a scheduled transmission time slot allocated by the AP. The RTT2b subcomponent may be dependent on the load of the AP. However, statistics of the RTT2b subcomponent may be the same for most MNs in the same priority level served by the same AP.

The subcomponent RTT2c represents the portion of the round trip time between the AP and the MN that is associated with the time 416A for a packet to be transmitted from the AP to the MN (in the downlink direction), and the time 416B for the corresponding acknowledgment to be transmitted form the MN to the AP (the uplink direction). The packet transmission time depends on the data rate, which in turn depends on the quality of the wireless link. The RTT2b subcomponent includes time for any retransmissions due to loss of a packet or loss of an acknowledgement. Since the RTT2b subcomponent is dependent on the quality of the wireless link, RTT2b may vary highly between different MNs served by the same AP.

The subcomponent RTT2d represents the portion of the round trip time between the AP and the MN that includes packet queuing delay 418 within a MN in the uplink direction. This delay depends on the traffic volume of the MN and the wireless channel capacity that is supported between the MN and the AP.

Estimates of the sum RTT2a+RTT2b can be used as estimates of RTT2_{common}. RTT2a and RTT2b are dependent on activity associated with the AP, but are relatively independent of the specific MN that is communicating with the AP. Therefore, an estimate of the sum RTT2a+RTT2b can be made by aggregating over the MNs. For a particular access point APⱼ, the HA (e.g., the LMA) is able to measure RTT2 for each mobile node MN₁ to MNₙ associated with APⱼ. The value RTT2ⱼₙ represents the mean RTT2 measured between the HA and MNₙ for traffic flowing through APⱼ. The minimum of the set of mean RTT2 measurements (RTT2ⱼ₁, RTT2ⱼ₁, . . . , RTT2ⱼₙ) may be used as an upper bound estimate of RTT2a+RTT2b (and therefore an upper bound estimate of RTT2_{common}), and this upper bound can be included in the RTT2 statistical data set. The upper bound estimate, or any other information included in the RTT2 statistical data set, can be modified to take into account other information (e.g., previously acquired information).

Each MN is then able to use that RTT2 statistical data set and locally determined estimates to estimate the total RTT2 that applies to that particular MN. A particular MN that initiates the attachment procedure is able to generate a local estimate of RTT2c based on the wireless transmission signal quality it receives from the AP, and a local estimate of RTT2d based on the volume of traffic it expects to flow through the AP. The MN is able to add the sum of the locally determined estimates RTT2c+RTT2d to the estimate of RTT2a+RTT2b from obtained from the HA to obtain an estimate of the total RTT2.

The schemes described herein to estimate path quality for the path selection procedure are applicable to a wide variety of protocols, and the functions of the LMA and MAG described above may be performed along with a various additional functions for providing mobility services. For example, mobile access technologies other than Mobile IP and WLAN can be used to provide a variety of functionality including tunneling, such as the GPRS Tunneling Protocol (GTP). Some protocols use various other entities to provide the functionality described herein. In the 3GPP EPC protocol, for mobility between 3GPP and non-3GPP access points (e.g., WLAN), the LMA function is performed by an entity called a Packet Data Network Gateway (PDN-GW). In PMIPv6, an entity called an Evolved Packet Data Gateway (e-PDG) performs functions of the MAG, and a mobility tunnel is setup between the e-PDG and the PDN-GW. 3GPP enables roaming scenarios where there is a mobility tunnel between the e-PDG and an entity called a Serving Gateway (S-GW), concatenated with a mobility tunnel between the S-GW and the PDN-GW. Thus, in some implementations of the mobile system, the segment 2 includes nodes that are configured to provide a concatenation of multiple tunnels. In the following example, a scheme for RTT2 estimation is described when multiple tunnels are concatenated.

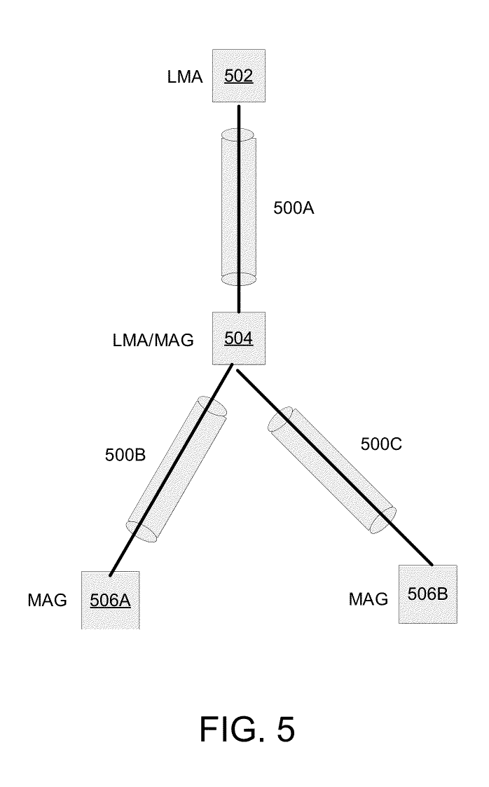

FIG. 5 shows a configuration which, for simplicity, illustrates concatenation of two tunnels, but the scheme can be extended to configurations with concatenation of more than two tunnels. In this configuration, a tunnel 500A has been set up between an LMA 502 and an LMA/MAG 504, a tunnel 500B has been set up between the LMA/MAG 504 and a MAG 506A, and a tunnel 500C has been set up between the LMA/MAG 504 and a MAG 506B.

The LMA/MAG 504 is a hybrid node that acts as the MAG for tunnel 500A and acts as the LMA for each of tunnels 500B and 500C. In the case of 3GPP, the functionality of the MAG 506A, the LMA/MAG 504, and the LMA 502 are provided by a e-PDG, a S-GW, and a PDN-GW, respectively.

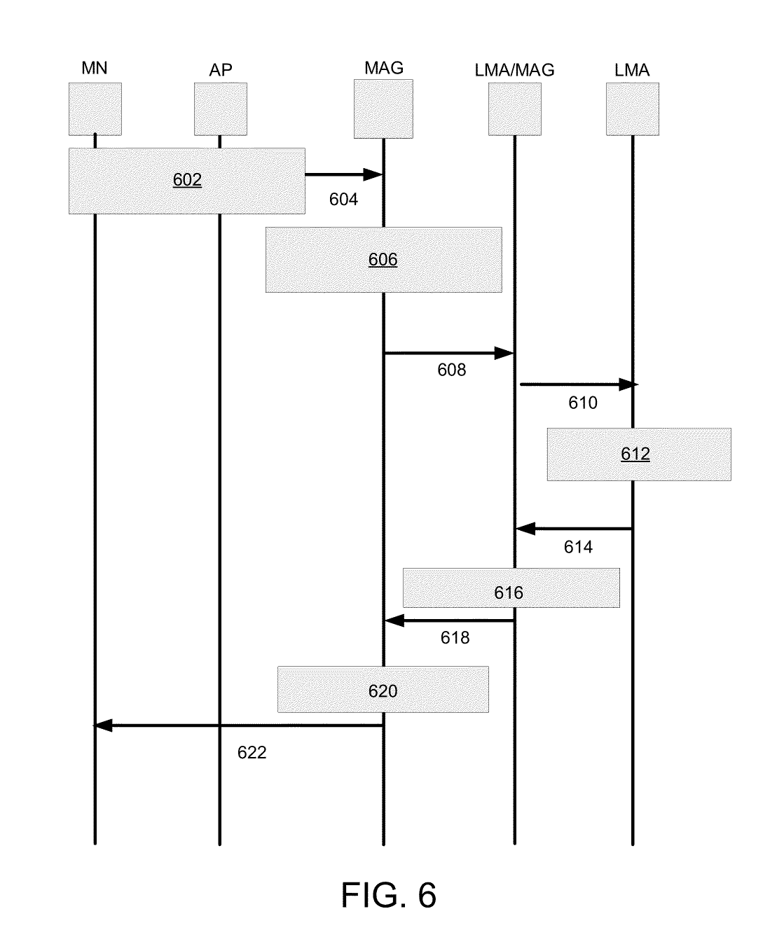

FIG. 6 is a communication diagram showing steps for providing RTT2 statistical data to an MN for path quality estimation in a configuration with a concatenated tunnel This exemplary attachment procedure is similar to the procedure shown in FIG. 3, but has some modifications to account for the presence of the additional node LMA/MAG between the LMA and the MAG (e.g., 506A or 506B). The MN sends (602) a request to initiate an attachment procedure with the AP. The AP triggers (604) the MAG functionality to perform attachment operations as described above (e.g., step 1) including building a PBU. Additionally, if path quality estimation is requested, the MAG associates (606) an AP identifier (identifying the AP that received the attachment request) with a corresponding outgoing PBU. For example, the MAG includes in the PBU the AP identifier, and a Boolean “RTT2 request” flag also included in the PBU. The MAG sends (608) the PBU to the LMA/MAG, as described above (e.g., step 2). The LMA/MAG sends (610) the PBU to the LMA, as described above (e.g., step 2). The LMA, in response to the PBU, performs attachment operations as described above (e.g., step 3) including allocating the HNP(s). Additionally, if the “RTT2 request” flag is true, the LMA generates (612) an HNP-to-AP identifier mapping. The LMA sends (614) a PBA to the LMA/MAG, as described above (e.g., step 4). Additionally, if the “RTT2 request” flag is true, the LMA includes in the PBA the RTT2 statistical data associated with the AP identified by the AP identifier. The LMA/MAG sets up (616) the tunnel towards the LMA if the tunnel is not already set up, as described above (e.g., step 5). The LMA/MAG sends (618) the PBA to the MAG. The MAG sets up (620) the tunnel towards the LMA/MAG if the tunnel is not already set up, as described above (e.g., step 5). Additionally, the MAG measures the PBU_{RTT}, according to the time elapsed between sending the PBU and receiving the PBA. The MAG sends (622) a Router Advertisement to the MN, as described above (e.g., step 6). Additionally, the MAG includes in the Router Advertisement the RTT2 statistical data received form the LMA and the measured PBU_{RTT}.

As an option, the MAG can provide the RTT2 statistical data associated with the neighboring APs, in addition to the RTT2 statistical data associated with the requesting AP. The procedure illustrated in FIG. 6 can be modified as follows to provide data for multiple APs/candidate paths. The MAG includes the list of neighboring AP identifiers in the PBU, instead of a single AP identifier. The LMA/MAG includes that same list in the PBU. The LMA sends the RTT2 statistical data for all the APs identified in the list. The LMA/MAG sends that same RTT2 statistical data to the MAG. The MAG sends the RTT2 statistical data for all the APs identified in the list to the MN. In the multi-path communication case, the same RTT2 measurement for each AP identifier is performed, but the RTT2 statistical data is used by the LMA to select the path to be used for traffic going towards the MN.

Various other modifications of the path quality estimation and selection procedures are possible. For example, if IP QoS schemes such as Diffsery are used on segment 2, the quality estimation techniques can be used for estimating the quality associated with different types of traffic and determining which type of traffic is more likely to meet certain predetermined constraints on a given quality metric. In the Diffsery example, the techniques can be used for measuring and averaging the RTT2 for each Differentiated Services Code Point (DSCP) encoding. For example, if a MN is configured to use Assured Forwarding (AF) with class 2 and medium drop precedence, the MN is able to use the RTT2 estimate for AF, class 2 and medium drop precedence. In that case, there can be separate instances of the RTT2 statistical data set, one for each DSCP encoding. The MN may use that information to select the DSCP encoding to meet the constraint on RTT2.

If there is RTP traffic, the HA can use the “interarrival jitter” in the RTCP reports to estimate the path quality. A low interarrival jitter is an indicator of better quality. Interarrival jitter is associated with the end-to-end path between the CN and the MN, and therefore is associated with both segment 1 and segment 2.

In some implementations, the selection of the highest quality path is performed at a node other than the MN, such as at the HA. For example, the HA is provided with the list of candidate paths through respective candidate APs, and the HA can also be provided with information such as RSS, expected traffic volume, and QoS requirements of the requesting MN. Using the RTT2 statistical data, the HA determines the AP providing the highest quality path and sends the identity of that AP to a requesting MN. In an implementation that uses PMIPv6, the procedure illustrated in FIG. 3, can be modified as follows. Along with the actions of step 2, the MAG provides a PBU that includes multiple AP identifiers, corresponding to the candidate APs. The list of candidate APs can be established by the MAG based on information gathered about the geographically neighboring APs. Along with the actions of step 4, the LMA provides a PBA that includes the AP identifier of the selected AP (e.g., providing the highest quality path). Along with the actions of step 6, the MAG provides a Router Advertisement the AP identifier of the selected AP received from the LMA.

Techniques have been described for measuring the RTT for path segments based on TCP traffic in which TCP headers are detectable by the HA. In an environment in which some traffic is encrypted at a level below TCP (e.g., using IPSec), the corresponding TCP headers will not be detectable. However, a MN that communicates using encrypted data, or data for which TCP headers are not detectable for some other reason, can still benefit from path quality estimation based on RTT estimates if some other MNs are send traffic with detectable TCP headers that enable RTT2 statistics to be collected by the HA. Furthermore, not all encryption takes place at a level below TCP. For example, Secure Sockets Layer (SSL) Virtual Private Network (VPN) typically occurs at a layer above TCP and does not encrypt the TCP layer information.

FIG. 7 illustrates an alternative scheme for measuring the RTT for a path segment, such as measuring RTT2_{common} for the path segment between the HA and the AP. The scheme involves performing measurements at the two end nodes of the path segment, node 701A and node 701B (which may correspond, for example, to the HA and the AP). The nodes 701A and 701B support a shared path segment that is shared by any number of paths between hosts (e.g., 702A, 702B) in a first network domain 703A and hosts (e.g., 702C, 702D) in a second network domain 703B. One node 701A measures the time elapsed between transmission of a TCP packet sent to the other node 701B and reception of the corresponding acknowledgment from the host 702C at the end of the full path, which generates acknowledgments for received traffic. The round trip time as measured by node 701A is equal to RTTx+RTTy, where RTTx is the round trip time of traffic on the path segment between node 701A and node 701B, and RTTy is the round trip time of traffic on the path segment between node 701B and the host 702C. Node 701B similarly measures RTTy based on traffic sent to the host 702A. An estimate of RTTx is obtained by subtracting RTTy measured by node 701B from RTTx+RTTy measured by node 701A. The measurement can be performed for selected sample packets. For example, packets selected for measurement by node 701A are tagged by node 701A, so node 701B is able to determine the packets for which to perform the RTTy measurement.

As the round trip times may experience short term fluctuations, the RTTx sample measurements can be processed and aggregated to obtain statistically meaningful metrics. For example, the sample measurements can be aggregated over the flows and averaged over time to obtain an RTTx statistical data set, which can be used to estimate the quality of the path segment (e.g., unused capacity of the tunnel supported by the path segment). To account for differentiated QoS treatment, the RTT measurements can take place separately for each traffic class, for example, DSCP encoding in the case of Diffserv. A shared path segment such as this can occur, for example, with a Virtual Private Network (VPN) tunnel, or a mobility tunnel, such as in PMIPv6, or another type of tunnel, such as in Locator Identifier Separation Protocol (LISP). The segment can also shared by multiple traffic flows simply by virtue of routing.

FIG. 8 shows a communication diagram showing steps for estimating RTTx for a path segment between node 701A and node 701B. To measure the RTTx of a given packet received from a sending host 702A, node 701A processes (802) the packet including tagging the packet, starting a timer, and sending the tagged packet to node 701B. In response to receiving a tagged packet, the node 701B processes (804) the tagged packet, including starting a timer, and sending the tagged to the destination host 702C. The destination host 702C generates an acknowledgment of the packet, and sends (806) the acknowledgment to the node 701B. The node 701B responds (808) to the acknowledgment of the tagged packet by measuring the time elapsed since starting the timer RTTy, and includes the time RTTy in an acknowledgment sent to node 701A. In response to receiving the acknowledgment, node 701A responds (810) to the acknowledgment by measuring the time elapsed since starting the timer T, and calculates the time RTTx for the path segment between node 701A and node 701B as T−RTTy.

This alternative scheme for measuring the RTT for a path segment, also referred to as RTT subtraction, can be extended to measure the individual unused capacity of multiple back-to-back segments. For example, consider two back-to-back segments, S1 and S2. S1 is the segment between end nodes E1 and E2, and S2 is the segment between end nodes E2 and E3. In this example, RTTx and RTTy are the RTT of traffic on segments S1 and S2, respectively. RTTx and RTTy can be measured as follows. When node E1 measures the RTT of a given packet (to some host beyond node E3), it will tag that packet, start its timer, and send the tagged packet to node E2. In response to receiving a tagged packet, node E2 will start its timer and forward the tagged packet to E3. In response to receiving a tagged packet, node E3 will start its timer, and forward the tagged packet to a destination host. The destination host will generate an acknowledgement for the tagged packet that is sent back along the path to node E1, through nodes E3 and E2. In response to receiving the acknowledgment, node E3 will measure the time elapsed since its timer was started (T₃), attach the elapsed time T₃ to the acknowledgment, and send the acknowledgment to node E2. In response to receiving the acknowledgment, node E2 will measure the time elapsed since its timer was started (T₂), attach the elapsed time T₂ to the acknowledgment, and send the acknowledgment to node E1. Node E2 is able to calculate the RTTy for segment S2 as RTTy=T₂−T₃. In response to receiving the acknowledgment, node E1 will measure the time elapsed since its timer was started (T₁). Node E1 is able to calculate the RTTx for segment S1 as RTTx=T₁−T₂.

Node E1 is able to adaptively adjust the sampling strategy, depending on factors such as the processing and memory capacity of the node, or required statistical confidence, for example. If node E1 has indication that the quality of the path segments to the destination host is high, then frequent sampling may not be required. For example, in the case of cascaded segments, E1 may not need to request, through packet tagging, that nodes E2 and E3 measure samples of RTT if T₁ is low enough to indicate an acceptable path quality.

Various techniques can be used for packet tagging, including explicit tagging by including a tag in the packet whose RTT is to be measured, or implicit tagging. One example of explicit tagging uses a Generic Routing Encapsulation (GRE) tunnel between E1 and E2. GRE is a tunneling protocol that can be used, e.g., with Mobile IP protocols. The GRE header can be modified by using a spare bit in the “Reserved” field to carry a flag indicating that the packet is tagged. Another example of explicit tagging can be used when an IPv6 header is used, or in the case of tunneling with multiple encapsulated headers, if the outermost header is an IPv6 header. The IPv6 header can be modified by using a spare bit in the “Destination Options extension header” to carry a flag indicating that the packet is tagged. Additionally, node E1 may use an IPv6 Routing header to specify that the packets must be routed through node E2, as an alternative to tunneling.

In some cases, it may not be possible to include an explicit tag in the packets, because the original packet sent from the sending host may have a maximum size limit for most packets on the path to the destination host. In such cases, the following implicit tagging scheme can be used. Node E1 implicitly tags a packet by providing one or more templates to node E2. Whenever a packet matches a template, as described in more detail below, it is considered to be tagged, and node E2 performs the appropriate RTT measurements for a tagged packet. Node E1 is able to send the template(s) to node E2 ahead of time by including the template information within packets that do not have a maximum size limitation (e.g., SYN, SYN/ACK, ACK, or pure acknowledgements for the other direction). Alternatively, node E1 may be able to send the template(s) to node E2 by out-of-band signaling over a different communication channel.

A template for indicating whether a packet is tagged includes a set of one or more conditions that apply to one or more fields of a packet's headers. A packet matches the template if its header fields meet the conditions. An example of a condition of a template is: Hash(TCP sequence number)=X, where “Hash( ) is a predefined has function that returns a hash value, and “X” is a predetermined hash value. If a node has received a template with this condition, then whenever a packet has a TCP sequence number whose hash value equals X, the packet matches the template and is processed by E2 as a tagged packet.

Another example of a condition of a template is a configurable condition that indicates that a packet should be tagged at a predetermined frequency (e.g., every 10th packet or every 100th packet). For example, the condition may indicate a sampling period, and if a node has received a template with this condition, then whenever a segment of a packet contains a byte whose relative sequence number is an integral multiple of the sampling period, the packet matches the template and is processed by E2 as a tagged packet. This condition can be expressed using the following inequality:

TCP relative sequence number<k*sampling-period<=TCP relative sequence number+segment size

In this example, “sampling-period” is a configurable parameter that represents how frequently the RTT is to be sampled. The “TCP relative sequence number” is the relative sequence number of a segment of the packet. The “segment size” is the size of segments into which the packet has been segmented (as an integer representing the number of bytes). The condition is met if there exists some positive integer k for which the inequality is met. If sampling-period is set to an integral multiple M of the maximum segment size, then roughly one out of M packets will be tagged. The node E1 can thus control the frequency at which packets are tagged; and a larger value of sampling-period will result in packets being tagged less often.

More frequent measurements can be performed by including fields in the template such as the source and destination IP addresses, transport protocol number, the source and destination port numbers, or some subsets of those fields. For example, the RTT for traffic to or from a particular subnet can be measured by adding the condition: Prefix=X to the template, where “Prefix” is the prefix of the IP destination address, and “X” is a predetermined prefix value for which a packet is to be tagged. Alternatively, the frequency at which sampling is performed can be implicit at the TCP connection level. In that case, templates can be exchanged at TCP connection establishment by including template information within SYN, SYN/ACK, or ACK messages. The implicit convention is that the templates will apply to that TCP connection.

In some TCP connections, one direction can be characterized as a forward direction, which tends to carry large packets, and the other direction can be characterized as a reverse direction, which tends to carry small packets (e.g., pure acknowledgments). In bidirectional tunnels, there is a symmetry between the end nodes, and for the purpose of sampling the RTT, either end node can act as the node E1 in the above example, with the other end node acting as node E2 in the above example. For a given TCP connection, an end node should be configured to perform the functions of the node E2 if the flow from the other end node has characteristics of the forward direction (e.g., large data packets), since the node E2 is able to include the elapsed time information in the smaller packets of the reverse direction. An end node can be configured to determine if it should perform the functions of the node E2 by observing the size of the packet received from the other end node. If a packet incoming from the other end node has a size larger than a threshold and matches a template, the end node performs the functions of node E2 for that packet, and processes the packet as described above (e.g., as in step 802). The elapsed time information is included in packets in the reverse direction, which are typically small and have enough room for the elapsed time information. The techniques described above for explicit tagging can also be used for including elapsed time information within packets (e.g., within headers). For example, the elapsed time information can be carried in a GRE header or an IPv6 Destination Option extension header. One embodiment of carrying the elapsed time information (T_Elapsed) in a GRE header is to use a spare bit in the “Reserved” field to carry a flag indicating the header contains the T_Elapsed information; in that case, the T_Elapsed is contained in a field added to the GRE header. (This spare bit is different from the one used for explicit tagging of packets tagged for RTT measurement.)

The rate at which packet RTTs are sampled can be controlled by node E1 and node E2 based on a variety of factors, including for example its impact on processing load and memory requirements at nodes E1 and E2. Nodes E1 and E2 may negotiate and/or renegotiate to agree upon an average sampling rate, through in-band or out-of-band signaling. In-band signaling can use any packet that has a sufficiently large unused portion, such as SYN, SYN/ACK, ACK, or pure ACKs. Additionally, the following mechanisms can be used to deal with instantaneous fluctuations in the sampling capabilities of either end node. As the initiator, node E1 can control the rate at which packets are tagged, explicitly or implicitly. Node E2 can control the sampling rate in a variety of ways, including by not processing the tagged packet (e.g., because of processing and/or memory constraints) and by returning acknowledgments without the elapsed time information.

The RTT associated with a path segment can be measured for path quality estimation in a path selection procedure, or for other purposes. In multi-homed configurations, a destination host can be reached through multiple addresses. With schemes such as LISP, in which the traffic is carried to the destination address in a tunnel, there is a tunnel corresponding to each address. The RTT measurement schemes described herein can be applied to select the tunnel with best quality. The schemes can also be used to select the optimal VPN tunnel, when multiple VPN tunnels are available to choose from. The estimated quality based on RTT can indicate the amount of unused capacity, which can be used to decide how much more traffic could be admitted on the measured path segment. Node E1 can track the RTT for each DSCP encoding, which can give a hint to help determine an optimal DSCP encoding (e.g., the encoding that is able to meet a target RTT). The information can be used by existing flows currently on the path segment to adjust their DSCP encodings. It can also be used by flows entering the path segment to set their DSCP encodings.

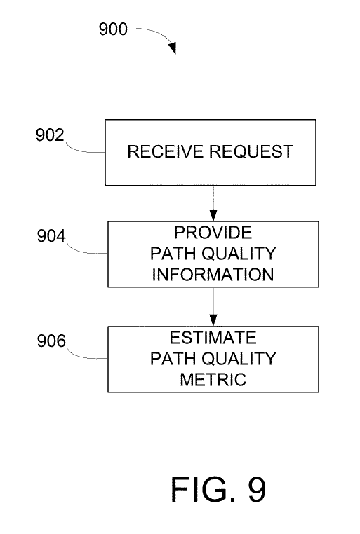

FIG. 9 shows a flowchart for an exemplary path quality estimation procedure 900, which may be part of a procedure that includes additional steps not shown. The procedure 900 includes receiving (902) a request to provide path quality information for selecting a path for communicating between the first node and a second node. A third node in the network that is in communication with the first node provides (904) the requested path quality information that includes a value of an additive path quality metric for a path segment between the third node and a fourth node, and a value of the additive path quality metric for a path segment between the third node and a fifth node. The second node estimates (906) values of the additive path quality metric for each of multiple different paths between the first node and the second node based at least in part on the path quality information provided by the third node. At least two of the multiple different paths include at least one path segment in common.

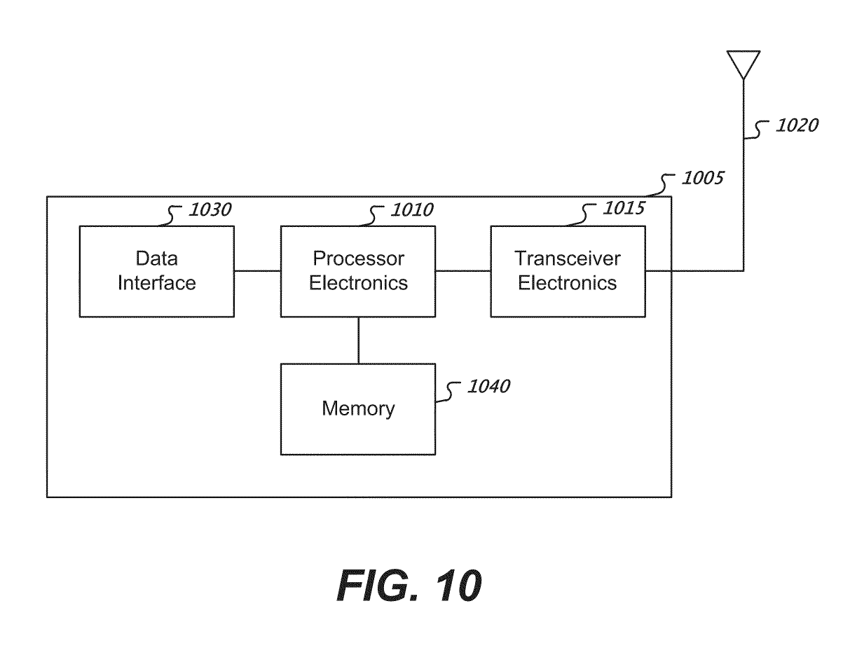

FIG. 10 shows an example of a radio station architecture for use in a wireless communication system. Various examples of radio stations include base stations and wireless devices. A radio station 1005 such as a base station or a wireless device can include processor electronics 1010 such as a processor that implements one or more of the techniques presented in this document. A radio station 1005 can include transceiver electronics 1015 to send and receive wireless signals over one or more communication interfaces such as one or more antennas 1020. A radio station 1005 can include other communication interfaces for transmitting and receiving data. In some implementations, a radio station 1005 can include one or more wired network interfaces to communicate with a wired network. In other implementations, a radio station 1005 can include one or more data interfaces 1030 for input/output (I/O) of user data (e.g., text input from a keyboard, graphical output to a display, touchscreen input, vibrator, accelerometer, test port, or debug port). A radio station 1005 can include one or more memories 1040 configured to store information such as data and/or instructions. In still other implementations, processor electronics 1010 can include at least a portion of transceiver electronics 1015.

The path quality estimation techniques described herein may be implemented in a number of computing devices, including, without limitation, servers, suitably programmed general purpose computers 1005 in FIG. 10, and mobile devices including such computers (e.g. mobile nodes 102A-102C). The techniques may be implemented by way of software containing instructions for configuring a processor 1010 to carry out the functions described herein. The software instructions may be stored on any suitable computer-readable memory 1040, including CDs, RAM, ROM, flash memory, etc.

It will be understood that the communication nodes described herein and the module, routine, process, thread, or other software component implementing the described method/process performed by the nodes may be realized using standard computer programming techniques and languages. The techniques described herein are not limited to particular processors, computer languages, computer programming conventions, data structures, or other such implementation details. The described processes may be implemented as a part of computer-executable code stored in volatile or non-volatile memory, as part of an application-specific integrated chip (ASIC), etc.

In one aspect, in general, a method for communicating between a first node in a network and a second node includes determining, by a third node in the network that is in communication with the first node, a value of an additive path quality metric for a path segment between the third node and a fourth node, and a value of the additive path quality metric for a path segment between the third node and a fifth node. The method also includes estimating path quality for each of multiple different paths between the first node and the second node based at least in part on the values of the additive path quality metric determined by the third node. At least two of the multiple different paths include at least one path segment in common.

In another aspect, in general, a computer readable storage medium stores a computer program for communicating between a first node in a network and a second node in the network. The computer program includes instructions for causing a computer processor to: determine, by a third node in the network that is in communication with the first node, a value of an additive path quality metric for a path segment between the third node and a fourth node, and a value of the additive path quality metric for a path segment between the third node and a fifth node; and estimate values of the additive path quality metric for each of multiple different paths between the first node and the second node based at least in part on the values of the additive path quality metric determined by the third node, at least two of the multiple different paths including at least one path segment in common

In another aspect, in general, a system comprises: a communication interface configured to communicate with a first node in a network; and at least one processor coupled to the communication interface to process information for communicating with a second node. The processing includes: determining a value of an additive path quality metric for a path segment between the communication interface and a third node, and a value of the additive path quality metric for a path segment between the communication interface and a fourth node; and transmitting the determined values of the additive path quality metric to the first node for estimating values of the additive path quality metric for each of multiple different paths between the first node and the second node based at least in part on the determined values of the additive path quality metric, at least two of the multiple different paths including at least one path segment in common.

Aspects can include one or more of the following features.

The first node comprises a correspondent node in the network, the second node comprises a mobile node, the third node comprises an agent node in the network, the fourth node comprises a first access node in the network, and the fifth node comprises a second access node in the network.

The at least two of the multiple different paths comprise: a first path between the correspondent node and the mobile node that includes the agent node and the first access node, and a second path between the correspondent node and the mobile node that includes the agent node and the second access node.

The method further comprises selecting one of the multiple different paths between the first node and the second node for communication between the first node and the second node, based at least in part on the estimated path quality for each of the multiple different paths.

The additive path quality metric for the path segment between the third node and a fourth node comprises a round trip time of data traffic on the path segment between the third node and the fourth node.

The data traffic originates from a node other than the second node.

The at least one path segment in common comprises a path segment between the first node and the third node.

Estimating path quality for a first path of the multiple different paths between the first node and the second node comprises: receiving, at the second node, first segment quality information derived from the value of the additive path quality metric for the path segment between the third node and the fourth node; estimating second segment quality information for a path segment between the fourth node and the second node; and estimating a path quality for the first path based on a sum of the first segment quality information and the second segment quality information.

Estimating the second segment quality information for the path segment between the fourth node and the second node comprises measuring a received signal strength of a wireless signal transmitted from the fourth node and received at the second node.

The first segment quality information is sent to the second node by the third node.

The first segment quality information is sent to the second node by a sixth node that stores segment quality information for multiple path segments.

Aspects can have one or more of the following advantages.

Estimating an additive metric, such as round trip time, based on current or recent traffic enables path quality to be estimated without always requiring a node to send probes such as pings or chirps. Additionally, while a probe may represent a snapshot of the congestion level on a path segment, collecting statistical information for a path that has a fluctuating traffic load (e.g., due to the bursty nature of data traffic) enables stable estimates without significant overhead due to repeated probes. Use of actual traffic instead of, or in addition to, probes provides accurate estimates of path quality. Collecting sampled measurements across traffic flows and over time improves the statistical significance of the collected samples. Both network resources and wireless access resources are used efficiently, since a large amount of additional traffic is not required. Traffic due to signaling overhead can be kept to a low level, for example, by including signaling information (e.g., requests, RTT estimates, and tagging templates) within existing acknowledgment or signaling traffic. The frameworks of protocols such as Mobile IP, including the security framework, can be leveraged. Some implementations do not require modifications to the access points. Some implementations enable quality estimation of individual segments on a path.

Other features and advantages of the invention are apparent from the present description, and from the claims.

Certain adaptations and modifications of the described embodiments can be made. Therefore, the above discussed embodiments are considered to be illustrative and not restrictive.

What is claimed is:

1. A method for communicating between a first node in a network and a second node, the method comprising:
determining, by a third node in the network that is in communication with the first node, a value of an additive path quality metric for a path segment between the third node and a fourth node, and a value of the additive path quality metric for a path segment between the third node and a fifth node; and
estimating path quality for each of multiple different paths between the first node and the second node based at least in part on the values of the additive path quality metric determined by the third node, at least two of the multiple different paths including at least one path segment in common.

2. The method of claim 1, wherein the first node comprises a correspondent node in the network, the second node comprises a mobile node, the third node comprises an agent node in the network, the fourth node comprises a first access node in the network, and the fifth node comprises a second access node in the network.

3. The method of claim 2, wherein the at least two of the multiple different paths comprise: a first path between the correspondent node and the mobile node that includes the agent node and the first access node, and a second path between the correspondent node and the mobile node that includes the agent node and the second access node.

4. The method of claim 1, further comprising selecting one of the multiple different paths between the first node and the second node for communication between the first node and the second node, based at least in part on the estimated path quality for each of the multiple different paths.

5. The method of claim 1, wherein the additive path quality metric for the path segment between the third node and a fourth node comprises a round trip time of data traffic on the path segment between the third node and the fourth node.

6. The method of claim 5, wherein the data traffic originates from a node other than the second node.

7. The method of claim 1, wherein the at least one path segment in common comprises a path segment between the first node and the third node.

8. The method of claim 1, wherein estimating path quality for a first path of the multiple different paths between the first node and the second node comprises:
receiving, at the second node, first segment quality information derived from the value of the additive path quality metric for the path segment between the third node and the fourth node;
estimating second segment quality information for a path segment between the fourth node and the second node; and
estimating a path quality for the first path based on a sum of the first segment quality information and the second segment quality information.

9. The method of claim 8, wherein estimating the second segment quality information for the path segment between the fourth node and the second node comprises measuring a received signal strength of a wireless signal transmitted from the fourth node and received at the second node.

10. The method of claim 8, wherein the first segment quality information is sent to the second node by the third node.

11. The method of claim 8, wherein the first segment quality information is sent to the second node by a sixth node that stores segment quality information for multiple path segments.

12. A computer readable, non-transitory storage medium storing a computer program for communicating between a first node in a network and a second node in the network, the computer program including instructions for causing a computer processor to:
determine, by a third node in the network that is in communication with the first node, a value of an additive path quality metric for a path segment between the third node and a fourth node, and a value of the additive path quality metric for a path segment between the third node and a fifth node; and
estimate values of the additive path quality metric for each of multiple different paths between the first node and the second node based at least in part on the values of the additive path quality metric determined by the third node, at least two of the multiple different paths including at least one path segment in common.

13. A system for communicating between a first node in a network and a second node, comprising:
a communication interface configured to communicate with a first node in a network; and
at least one processor coupled to the communication interface to process information for communicating with a second node, the processing including:
determining a value of an additive path quality metric for a path segment between the communication interface and a third node, and a value of the additive path quality metric for a path segment between the communication interface and a fourth node; and
transmitting the determined values of the additive path quality metric to the first node for estimating values of the additive path quality metric for each of multiple different paths between the first node and the second node based at least in part on the determined values of the additive path quality metric, at least two of the multiple different paths including at least one path segment in common.

14. The system of claim 13, wherein the first node comprises a correspondent node in the network, the second node comprises a mobile node, the third node comprises an agent node in the network, the fourth node comprises a first access node in the network, and the fifth node comprises a second access node in the network.

15. The system of claim 14, wherein the at least two of the multiple different paths comprise: a first path between the correspondent node and the mobile node that includes the agent node and the first access node, and a second path between the correspondent node and the mobile node that includes the agent node and the second access node.

16. The system of claim 13, the processing further including selecting one of the multiple different paths between the first node and the second node for communication between the first node and the second node, based at least in part on the estimated path quality for each of the multiple different paths.

17. The system of claim 13, wherein the additive path quality metric for the path segment between the third node and a fourth node comprises a round trip time of data traffic on the path segment between the third node and the fourth node.

18. The system of claim 17, wherein the data traffic originates from a node other than the second node.

19. The system of claim 13, wherein the at least one path segment in common comprises a path segment between the first node and the third node.

20. The system of claim 13, wherein estimating path quality for a first path of the multiple different paths between the first node and the second node comprises:
receiving, at the second node, first segment quality information derived from the value of the additive path quality metric for the path segment between the third node and the fourth node;
estimating second segment quality information for a path segment between the fourth node and the second node; and
estimating a path quality for the first path based on a sum of the first segment quality information and the second segment quality information.

21. The system of claim 20, wherein estimating the second segment quality information for the path segment between the fourth node and the second node comprises measuring a received signal strength of a wireless signal transmitted from the fourth node and received at the second node.

22. The system of claim 20, wherein the processing further includes sending the first segment quality information to the second node.

23. The system of claim 20, wherein the first segment quality information is sent to the second node by a sixth node that stores segment quality information for multiple path segments.
